(19) United States
(12) Patent Application Publication
(10) Pub. No.: US 2025/0202079 A1
(43) Pub. Date: Jun. 19, 2025

(54) TERMINAL CONNECTION WITH COVER PLATES FOR EXTERNAL TABS OF BATTERY CELLS

(71) Applicant: GM Global Technology Operations LLC, Detroit, MI (US)

(72) Inventors: Teresa Jean RINKER, Royal Oak, MI (US); Masoud Mohammadpour, Novi, MI (US); Junjie Ma, Novi, MI (US); Hui-ping Wang, Troy, MI (US)

(21) Appl. No.: 18/541,748

(22) Filed: Dec. 15, 2023

(51) Int. Cl. H01M 50/553; H01M 50/15; H01M 50/536

(52) U.S. Cl. CPC H01M 50/553; H01M 50/15; H01M 50/536

(57) ABSTRACT

A battery cell includes a stack including C cathode electrodes each including a cathode current collector, a cathode active layer, and an external tab, A anode electrodes each including an anode current collector, an anode active layer, and an external tab, and S separators, an internal terminal including a first slot, wherein the external tabs of one of the C cathode electrodes and the A anode electrodes extend through the first slot, and a cover plate in contact with the external tabs of the one of the C cathode electrodes and the A anode electrodes extending through the first slot. The external tabs of the one of the C cathode electrodes and the A anode electrodes extending through the first slot are folded and laser welded between the cover plate and a surface of the internal terminal.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to laser welded internal terminals and cover plates for external tabs of battery cells.

Electric vehicles (EVs) such as battery electric vehicles (BEVs), hybrid vehicles, and/or fuel cell vehicles include one or more electric machines (e.g., motors) and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes a stack including C cathode electrodes each including a cathode current collector, a cathode active layer arranged on the cathode current collector, and an external tab extending from the cathode current collector, A anode electrodes each including an anode current collector, an anode active layer arranged on the anode current collector, and an external tab extending from the anode current collector, and S separators, where C, A and S are integers greater than one, an internal terminal including a first slot, wherein the external tabs of one of the C cathode electrodes and the A anode electrodes extend through the first slot, and a cover plate in contact with the external tabs of the one of the C cathode electrodes and the A anode electrodes extending through the first slot. The external tabs of the one of the C cathode electrodes and the A anode electrodes extending through the first slot are folded and laser welded between the cover plate and a surface of the internal terminal.

In some examples, the external tabs of the one of the C cathode electrodes and the A anode electrodes are separated into a first group and a second group, folded in first and second directions, respectively, and laser welded between the cover plate and the surface of the internal terminal on opposite sides of the first slot.

In some examples, the internal terminal is “L”-shaped and includes a first portion and a second portion extending transversely relative to the first portion.

In some examples, the cover plate, and first portion and the second portion of the internal terminal each have a rectangular shape, the first slot is defined in the second portion of the internal terminal, and a plane of the cover plate and a plane of the second portion of the internal terminal are each perpendicular to an extension direction of the external tabs of the one of the C cathode electrodes and the A anode electrodes through the first slot.

In some examples, the internal terminal includes N of the first slot, where N is an integer greater than one.

In some examples, the external tabs of the one of the C cathode electrodes and the A anode electrodes are divided into N groups that extend through the N first slots, respectively, and are folded and laser welded between the cover plate and the surface of the internal terminal.

In some examples, the cover plate includes a second slot, and at least a portion of the external tabs are welded adjacent the second slot of the cover plate.

In some examples, the cover plate includes M of the second slot, where M is an integer greater than one.

In some examples, the external tabs of the one of the C cathode electrodes and the A anode electrodes are divided into M groups, and the external tabs of the M groups are welded adjacent the M second slots, respectively.

In some examples, the external tabs of the one of the C cathode electrodes and the A anode electrodes extending through the first slot are edge welded between the cover plate and the surface of the internal terminal.

In some examples, the external tabs of the one of the C cathode electrodes and the A anode electrodes extending through the first slot are overlap welded between the cover plate and the surface of the internal terminal.

In some examples, the first slot is open-ended. In some examples, the battery cell includes an enclosure, and an external terminal of the enclosure, where the external terminal is in contact with the internal terminal.

In some examples, the stack comprises a prismatic battery cell stack, and the enclosure is a can enclosure configured to enclose the prismatic battery cell stack.

In some examples, the battery cell includes a second internal terminal including a second slot to receive the external tabs of the other one of the C cathode electrodes and the A anode electrodes.

In some examples, portions of the external tabs of the other one of the C cathode electrodes and the A anode electrodes extending through the second slot are folded and laser welded to a surface of the second internal terminal.

A battery cell includes a stack including C cathode electrodes each including a cathode current collector, a cathode active layer arranged on the cathode current collector, and an external tab extending from the cathode current collector, A anode electrodes each including an anode current collector, an anode active layer arranged on the anode current collector, and an external tab extending from the anode current collector, and S separators, where C, A and S are integers greater than one, and an internal terminal including a first slot and a second slot. A width of the first slot in a direction transverse to a longitudinal direction of the internal terminal is different than a width of the second slot in the direction transverse to the longitudinal direction of the internal terminal, the external tabs of the one of the C cathode electrodes and the A anode electrodes are separated into a first group and a second group, the external tabs of the first group extend through the first slot, and are folded and laser welded to a surface of the internal terminal at a side of the first slot, and the external tabs of the second group extend through the second slot, and are folded and laser welded to the surface of the internal terminal at a side of the second slot.

In some examples, the battery cell includes a cover plate in contact with the external tabs of the first group and the second group, wherein the external tabs of the first group and the second group are laser welded between the cover plate and the surface of the internal terminal.

In some examples, the cover plate includes a first portion and a second portion, and the first portion has a width in a direction transverse to a longitudinal direction of the cover plate which is different than a width of the second portion in the direction transverse to the longitudinal direction of the cover plate.

In some examples, the width of the first portion of the cover plate corresponds to the width of the first slot of the internal terminal, and the width of the second portion of the cover plate corresponds to the width of the second slot of the internal terminal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell;

FIG. 2 is a perspective view of an example of a prismatic battery cell including laser welded internal terminals that are in contact with external terminals according to the present disclosure;

FIG. 3 is a perspective view of an example of a prismatic battery cell including electrodes with external tabs that are to be laser welded to the internal terminals;

FIG. 4 is a perspective view illustrating joining of the external tabs of electrodes to an inner surface of an internal terminal;

FIGS. 5A to 5D, are cross sectional illustrations of examples of connection of external tabs to terminals, where the cross section plane is illustrated at A-A in FIG. 3;

FIGS. 5E and 5F are examples of weld cross sections where external tabs are welded to pre-welded foils and not pre-welded foils, respectively;

FIGS. 6A to 6D are perspective views and sequence illustrating an example of a cover plate, internal terminals with one or more slots, and external tabs of electrodes laser welded between the cover plate and the internal terminals, in or through the one or more slots, according to the present disclosure;

FIGS. 7A to 7D are perspective views and sequence illustrating examples of a cover plate including multiple slots, internal terminals with one or more slots, and external tabs of electrodes laser welded between the cover plate and the internal terminals, where the laser beam shines on the tabs of electrodes through the slots in the cover plate;

FIGS. 8A to 8D are perspective views and sequence illustrating examples of a cover plate including a single slot, internal terminals with one or more slots, and external tabs of electrodes laser welded between the cover plate and the internal terminals;

FIGS. 9A and 9B are top views illustrating laser and joint setup examples for edge welding and overlap welding external tabs between a cover plates and internal terminals; and

FIGS. 10A to 10C are perspective views illustrating examples of a stepped cover plate, internal terminals with multiple slots having different widths, and external tabs of electrodes laser welded between the cover plate and the internal terminals.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Some example embodiments described herein include designs for connection of external tabs of a battery cell (e.g., battery electrode foils) to a terminal of the battery cell, by inserting the external tabs through slot(s) in the terminal, and welding the external tabs between a cover plate (e.g., a top plate) and a surface of the terminal adjacent the slot(s). In some examples, the battery cell may be a prismatic battery cell for a vehicle.

The external tabs of the battery cell may be connected via, e.g., laser edge welding or laser overlap welding, where the external tabs are folded and sandwiched between the cover plate and the internal terminal of the battery cell. In some examples, the internal terminal and/or the cover plate may include multiple slots to facilitate welding of multiple groups of external tabs. The groups of external tabs may be folded in the same direction or opposite directions.

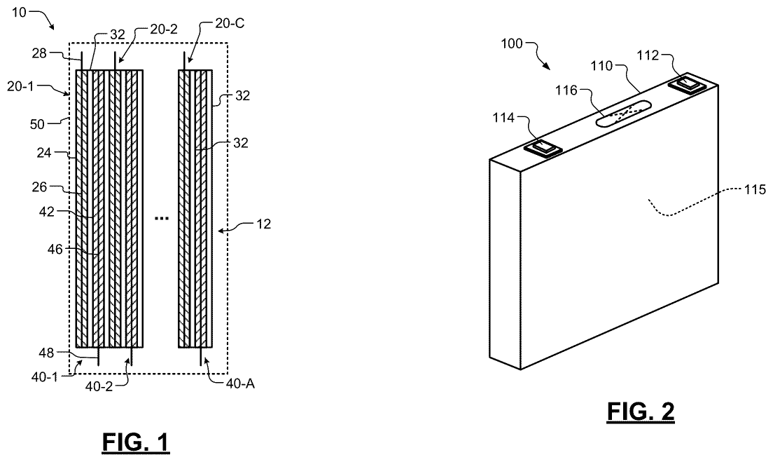

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The C cathode electrodes 20-1, 20-2, . . . , and 20-C include cathode active material layers 24 arranged on one or both sides of a cathode current collector 26.

During charging/discharging, the A anode electrodes 40 and the C cathode electrodes 20 exchange lithium ions. The A anode electrodes 40-1, 40-2, . . . , and 40-A include anode active material layers 42 arranged on one or both sides of the anode current collectors 46. In some examples, the cathode active material layers 24 and the anode active material layers 42 comprise coatings including one or more active materials, one or more conductive additives, and/or one or more binder materials that are applied to the current collectors.

In some examples, the cathode current collector 26 comprises metal foil, metal mesh, perforated metal, 3 dimensional (3D) metal foam, and/or expanded metal. In some examples, the anode current collector 46 comprises roughened metal foil (e.g., copper foil). In some examples, the current collectors are made of one or more materials selected from a group consisting of copper, stainless steel, brass, bronze, zinc, aluminum, and/or alloys thereof.

External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells as will be described further below.

Referring now to FIG. 2, a prismatic battery cell 100 includes an enclosure 110. In some examples, the enclosure 110 has a rectangular cross-section. The prismatic battery cell 100 includes external terminals 112 and 114 and a vent cap 116.

A stack 115 of the C cathode electrodes 20, the A anode electrodes 40, and the S separators 32 is arranged in the enclosure 110. As will be described further below, the anode current collectors 46 and/or the cathode current collectors 26 include external tabs that are laser welded to internal terminals contacting the external terminals 112 and 114 of the battery cell 10.

Referring now to FIG. 3, a prismatic battery cell 200 includes an enclosure 210 and internal terminals 224 and 226 arranged at opposite ends of the enclosure 210. A stack 240 of the C cathode electrodes, the A anode electrodes, and the S separators is arranged in the enclosure 210.

The anode current collectors and/or the cathode current collectors include external tabs 244 and 246 that extend therefrom, respectively. The external tabs 244 and 246 are laser welded to the internal terminals 224 and 226, respectively.

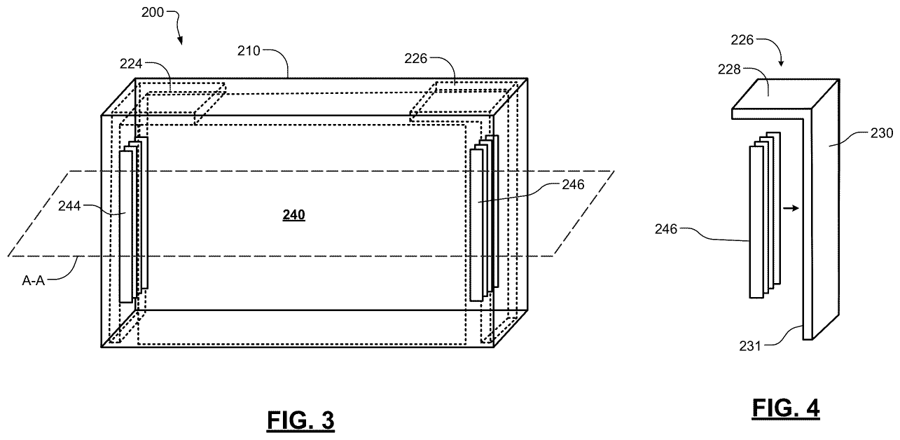

In FIG. 4, the internal terminal 226 includes a first portion 228 and a second portion 230 extending from the first portion 228. In some examples, the first portion 228 is “L”-shaped and forms an angle in a range from 80° to 100° (e.g., 90°) relative to the second portion 230.

In some examples, the external tabs 246 are laser welded to an inner surface 231 of the internal terminal 226, respectively. Laser welding the external tabs 244 and 246 using this approach is difficult. The internal terminal 226 contacts one of the external terminals 112 and 114 of the battery cell 10 to provide an external connection to the anode or cathode electrodes.

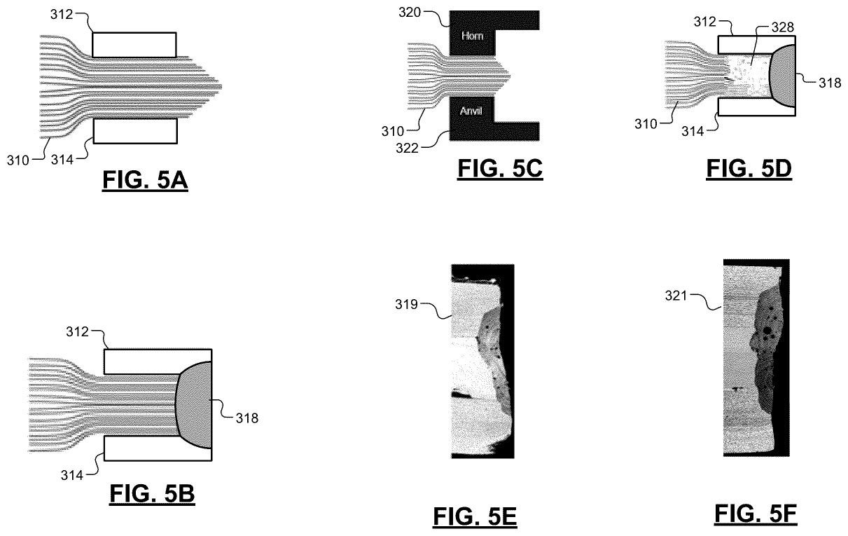

Referring now to FIGS. 5A to 5F, examples of connection of external tabs to terminals are shown. In FIGS. 5A and 5B, a plurality of external tabs 310 extending from the anode electrodes and cathode electrodes are arranged between terminals 312 and 314 and welded (e.g., laser welded) as shown at 318.

In FIGS. 5C and 5D, ultrasonic welding of the plurality of external tabs 310 can be performed prior to welding as shown at 328. For example, the plurality of external tabs 310 may be placed between a horn 320 and an anvil 322, in order to perform ultrasonic welding of the plurality of external tabs 310, as shown in FIG. 5C. The ultrasonic welded group of tabs may then be placed between terminals 312 and 314 for welding (e.g., laser welding) as shown at 318 in FIG. 5D.

In FIGS. 5E and 5F, enlarged illustrations of example welds between external tabs of foils and internal terminals are shown. FIG. 5E illustrates an example weld between external tabs of foils and internal terminals where the group of foils are pre-welded via ultrasonic welding as illustrated in FIG. 5C. FIG. 5F illustrates an example weld where the group of foils are not pre-welded prior to welding to internal terminals.

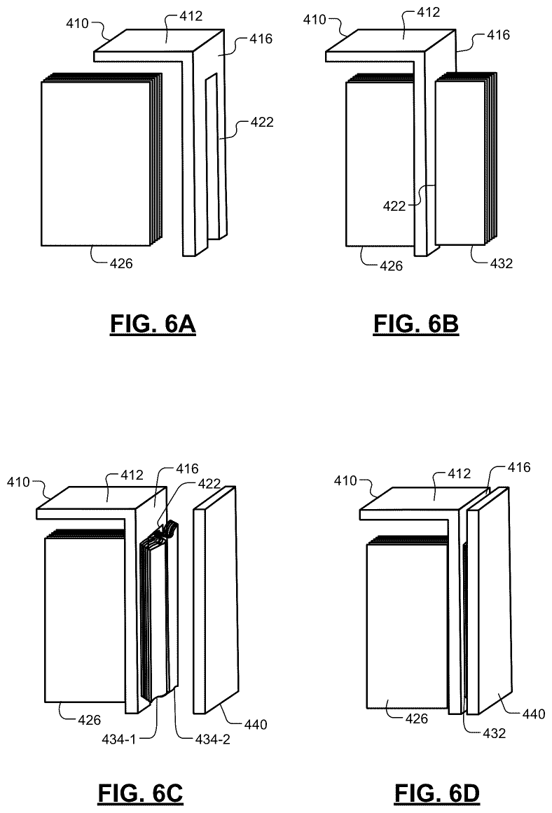

Referring now to FIGS. 6A to 6D, a terminal 410 includes a first portion 412 and a second portion 416 extending at an angle (e.g., approximately perpendicular) relative to the first portion 412. In some examples, the first portion 412 and the second portion 416 have a rectangular shape, although other shapes can be used.

The second portion 416 of the terminal 410 includes a slot 422 that extends in a longitudinal direction on the second portion 416. In some examples, the slot 422 extends to an edge of the second portion 416 distal from the first portion 412. In other examples, the slot 422 ends before reaching the edge of the second portion 416.

In FIG. 6B, a plurality of external tabs 426 is partially inserted into the slot 422. The plurality of external tabs 426 may be partially inserted into the slot by moving the plurality of external tabs 426 through the slot 422 in a direction perpendicular to a plane of the second portion 416, by dropping the slot 422 down onto the plurality of external tabs 426, etc.

Ends 432 of the plurality of external tabs 426 extend outwardly. The ends 432 of the plurality of external tabs 426 are separated into first and second tab groups 434-1 and 434-2 that fold in opposite directions parallel to and against an outer surface of the second portion 416 (e.g., as shown in FIG. 6C). For example, the first and second tab groups may bend at approximately ninety degree angles after passing through the slot 422.

In FIG. 6C, a cover plate 440 is arranged adjacent to the first and second tab groups 434-1 and 434-2, and welded as shown in FIG. 6D. In other words, the cover plate 440 is welded to the first and second tab groups 434-1 and 434-2 and the terminal 410.

For example, after the first and second tab groups 434-1 and 434-2 are inserted through the slot 422 and folded against the surface of the second portion 416 of the terminal 410, the cover plate 440 may be pressed against the folded first and second tab groups 434-1 and 434-2. The folded first and second tab groups 434-1 and 434-2 may then be welded between the terminal 410 and the cover plate 440, such as by laser edge welding, laser overlap welding, etc. The cover plate 440 may facilitate increased stability to the welding between the terminal 410 and the folded first and second tab groups 434-1 and 434-2, such as by providing another surface for welding, by applying additional force against the first and second tab groups 434-1 and 434-2, by protecting a side of the folded first and second tab groups 434-1 and 434-2 opposite the terminal 410, etc.

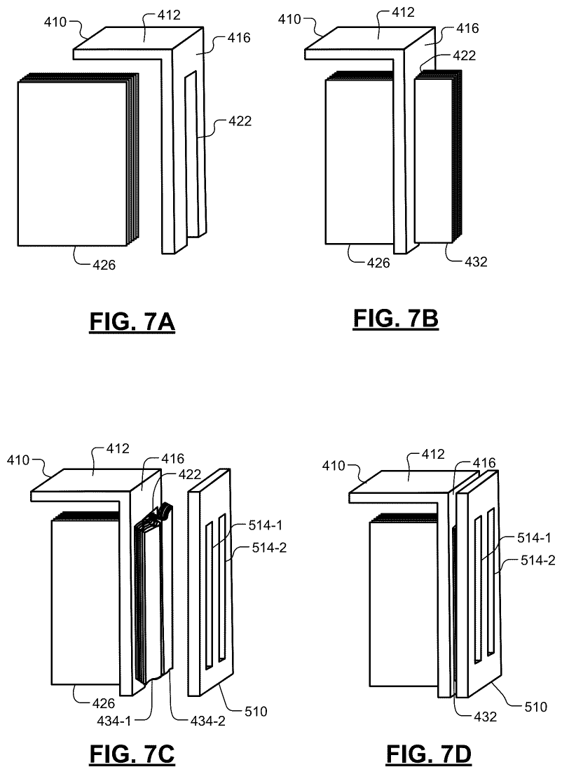

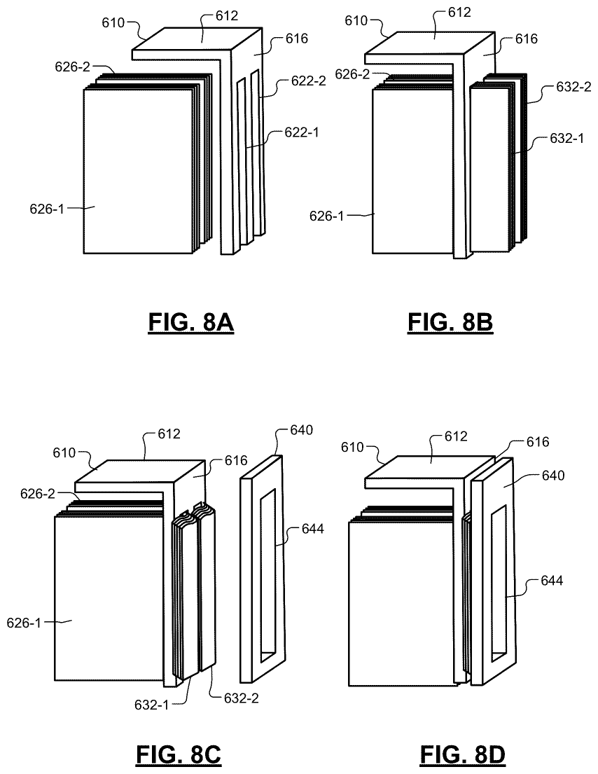

Referring now to FIGS. 7A to 7D, a cover plate 510 includes first and second slots 514-1 and 514-2 that extend longitudinally on the cover plate 510. In FIGS. 7C and 7D, the cover plate 510 is arranged in contact with the first and second tab groups 434-1 and 434-2 and welded. In other words, the cover plate 510 is welded to the first and second tab groups 434-1 and 434-2 and the terminal 410 through the first and second slots 514-1 and 514-2.

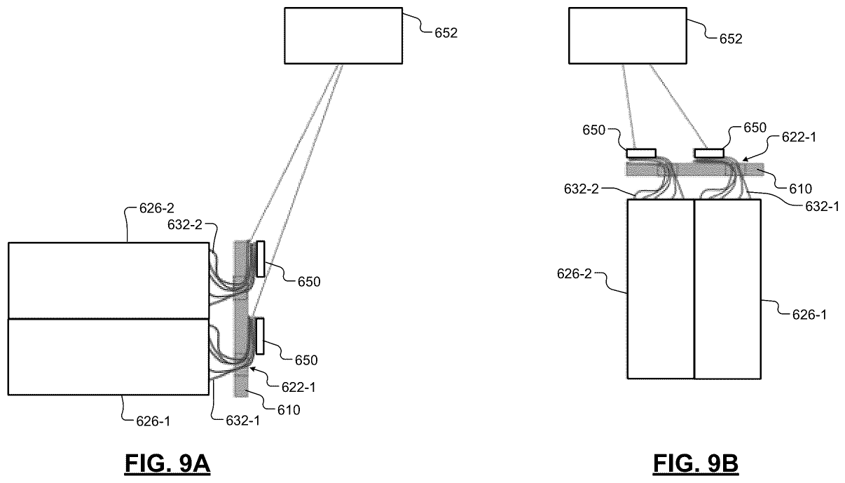

Referring now to FIGS. 8A to 8D, a terminal 610 includes a first portion 612 and a second portion 616 extending at an angle (e.g., approximately perpendicular) relative to the first portion 612. In some examples, the first portion 612 and the second portion 616 have a rectangular shape, although other shapes can be used.

The second portion 616 of the terminal 610 includes first and second slots 622-1 and 622-2 that extend in a longitudinal direction on the second portion 616. In some examples, the first and second slots 622-1 and 622-2 extend to an edge of the second portion 616 distal from the first portion 612. In other examples, first and second slots 622-1 and 622-2 end before reaching the edge of the second portion 616.

First and second sets of external tabs 626-1 and 626-2 are inserted into the first and second slots 622-1 and 622-2. Ends 632-1 and 632-2 extend from the first and second slots 622-1 and 622-2. In some examples, the ends 632-1 and 632-2 are folded in the same direction or a different direction.

In FIGS. 8C and 8D, a cover plate 640 includes a slot 644 that extends longitudinally on the second portion 616 of the terminal 610. The cover plate 640 is arranged in contact with the ends 632-1 and 632-2 and welded. In other words, the cover plate 640 is welded to the ends 632-1 and 632-2 and the terminal 610 through the slot 644 as shown in FIGS. 9A and 9B. The slot 644 of the cover plate 640 may have a greater width than the first and second slots 514-1 and 514-2 of the cover plate 510 of FIGS. 7C and 7D, which may facilitate additional space for welding the ends 632-1 and 632-2 of the first and second sets of external tabs 626-1 and 626-2.

FIG. 9A illustrates an example process for laser edge welding the ends 632-1 and 632-2 of the first and second sets of external tabs 626-1 and 626-2. For example, a laser 652 may be oriented to perform laser edge welding of the ends 632-1 and 632-2 between the terminal 610 and cover plates 650. FIG. 9B illustrates the laser 652 oriented to perform laser overlap welding of the ends 632-1 and 632-2 between the terminal 610 and cover plates 650.

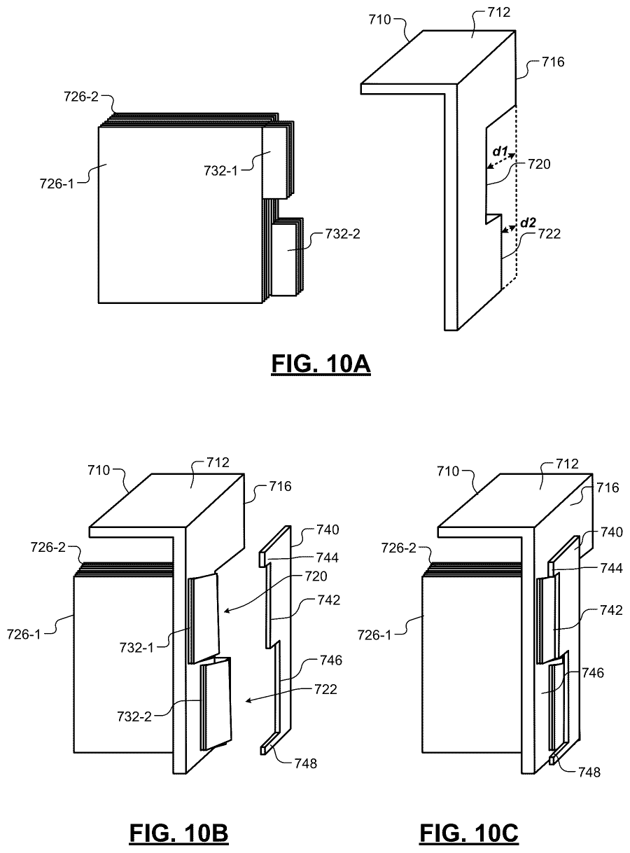

Referring now to FIGS. 10A to 10C, a terminal 710 includes a first portion 712 and a second portion 716 extending at an angle (e.g., approximately perpendicular) relative to the first portion 712. In some examples, the first portion 712 and the second portion 716 have a rectangular shape, although other shapes can be used.

The second portion 716 of the terminal 710 includes a first slot 720 and a second slot 722. In some examples, the first slot 720 extends a distance d1 in a direction transverse to a longitudinal direction. In some examples, the second slot 722 extends a distance d2 in a direction transverse to a longitudinal direction. In some examples, d1 is greater than d2. For example, the first slot 720 and the second slot 722 may define a stepped configuration, where the first slot 720 is above the second slot 722 in the longitudinal direction of the second portion 716, and an edge of the first slot 720 may be offset from an edge of the second slot 722 in the direction transverse to the longitudinal direction.

A first plurality of electrodes 726-1 includes external tabs 732-1 and a second plurality of electrodes 726-2 includes external tabs 732-2. The external tabs 732-1 extend through the first slot 720 and are folded transversely. The external tabs 732-2 extend through the second slot 722 and are folded transversely.

In some examples, the positions of the external tabs 732-1 and 732-2 may correspond to locations of the first slot 720 and the second slot 722, respectively. For example, the external tabs 731-1 may be located above the external tabs 732-2 in the longitudinal direction, and the external tabs 731-1 may be offset from the external tabs 732-2 in the direction transverse to the longitudinal direction. The external tabs 731-1 may be parallel to the external tabs 732-2.

In FIGS. 10B and 10C, a cover plate 740 includes a first slot 742 and a second slot 746. In some examples, the cover plate 740 also includes a projection 744 located above the first slot and a projection 748. In some examples, the projection 744, the first slot 742, and the second slot 746 define an inverted stair-stepped surface.

In some examples, the depth of the second slot 746 is less than the depth of the first slot 742. The location of the first and second slots 742 and 746 may correspond to the locations of the external tabs 732-1 and 732-2. In FIG. 10C, the cover plate 740 is welded to the second portion 716 and the external tabs 732-1 and 732-2.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery cell, comprising:
a stack including:
C cathode electrodes each including a cathode current collector, a cathode active layer arranged on the cathode current collector, and an external tab extending from the cathode current collector;
A anode electrodes each including an anode current collector, an anode active layer arranged on the anode current collector, and an external tab extending from the anode current collector; and
S separators, where C, A and S are integers greater than one;
an internal terminal including a first slot, wherein the external tabs of one of the C cathode electrodes and the A anode electrodes extend through the first slot; and
a cover plate in contact with the external tabs of the one of the C cathode electrodes and the A anode electrodes extending through the first slot,
wherein the external tabs of the one of the C cathode electrodes and the A anode electrodes extending through the first slot are folded and laser welded between the cover plate and a surface of the internal terminal.

2. The battery cell of claim 1, wherein the external tabs of the one of the C cathode electrodes and the A anode electrodes are separated into a first group and a second group, folded in first and second directions, respectively, and laser welded between the cover plate and the surface of the internal terminal on opposite sides of the first slot.

3. The battery cell of claim 1, wherein the internal terminal is “L”-shaped and includes a first portion and a second portion extending transversely relative to the first portion.

4. The battery cell of claim 3, wherein:
the cover plate, and first portion and the second portion of the internal terminal each have a rectangular shape;
the first slot is defined in the second portion of the internal terminal; and
a plane of the cover plate and a plane of the second portion of the internal terminal are each perpendicular to an extension direction of the external tabs of the one of the C cathode electrodes and the A anode electrodes through the first slot.

5. The battery cell of claim 1, wherein the internal terminal includes N of the first slot, where N is an integer greater than one.

6. The battery cell of claim 5, wherein the external tabs of the one of the C cathode electrodes and the A anode electrodes are divided into N groups that extend through the N first slots, respectively, and are folded and laser welded between the cover plate and the surface of the internal terminal.

7. The battery cell of claim 1, wherein the cover plate includes a second slot, and at least a portion of the external tabs are welded adjacent the second slot of the cover plate.

8. The battery cell of claim 7, wherein the cover plate includes M of the second slot, where M is an integer greater than one.

9. The battery cell of claim 8, wherein:
the external tabs of the one of the C cathode electrodes and the A anode electrodes are divided into M groups; and
the external tabs of the M groups are welded adjacent the M second slots, respectively.

10. The battery cell of claim 1, wherein the external tabs of the one of the C cathode electrodes and the A anode electrodes extending through the first slot are edge welded between the cover plate and the surface of the internal terminal.

11. The battery cell of claim 1, wherein the external tabs of the one of the C cathode electrodes and the A anode electrodes extending through the first slot are overlap welded between the cover plate and the surface of the internal terminal.

12. The battery cell of claim 1, wherein the first slot is open-ended.

13. The battery cell of claim 3, further comprising:
an enclosure; and
an external terminal of the enclosure, the external terminal in contact with the internal terminal.

14. The battery cell of claim 13, wherein the stack comprises a prismatic battery cell stack, and the enclosure is a can enclosure configured to enclose the prismatic battery cell stack.

15. The battery cell of claim 1, further comprising a second internal terminal including a second slot to receive the external tabs of the other one of the C cathode electrodes and the A anode electrodes.

16. The battery cell of claim 15, wherein portions of the external tabs of the other one of the C cathode electrodes and the A anode electrodes extending through the second slot are folded and laser welded to a surface of the second internal terminal.

17. A battery cell, comprising:
a stack including:
C cathode electrodes each including a cathode current collector, a cathode active layer arranged on the cathode current collector, and an external tab extending from the cathode current collector;
A anode electrodes each including an anode current collector, an anode active layer arranged on the anode current collector, and an external tab extending from the anode current collector; and
S separators, where C, A and S are integers greater than one; and
an internal terminal including a first slot and a second slot, wherein,
a width of the first slot in a direction transverse to a longitudinal direction of the internal terminal is different than a width of the second slot in the direction transverse to the longitudinal direction of the internal terminal,
the external tabs of the one of the C cathode electrodes and the A anode electrodes are separated into a first group and a second group,
the external tabs of the first group extend through the first slot, and are folded and laser welded to a surface of the internal terminal at a side of the first slot; and
the external tabs of the second group extend through the second slot, and are folded and laser welded to the surface of the internal terminal at a side of the second slot.

18. The battery cell of claim 17, further comprising a cover plate in contact with the external tabs of the first group and the second group, wherein the external tabs of the first group and the second group are laser welded between the cover plate and the surface of the internal terminal.

19. The battery cell of claim 18, wherein:
the cover plate includes a first portion and a second portion; and
the first portion has a width in a direction transverse to a longitudinal direction of the cover plate which is different than a width of the second portion in the direction transverse to the longitudinal direction of the cover plate.

20. The battery cell of claim 19, wherein the width of the first portion of the cover plate corresponds to the width of the first slot of the internal terminal, and the width of the second portion of the cover plate corresponds to the width of the second slot of the internal terminal.
